(19) United States
(12) Patent Application Publication
(10) Pub. No.: US 2011/0101954 A1
(43) Pub. Date: May 5, 2011

(54) REFERENCE SIGNAL GENERATOR AND METHOD FOR PROVIDING A REFERENCE SIGNAL WITH AN ADAPTIVE TEMPERATURE COEFFICIENT

(75) Inventors: SHAO-HUNG LU, TAOYUAN COUNTY (TW); ISAAC Y. CHEN, HSINCHU COUNTY (TW)

(73) Assignee: RICHTEK TECHNOLOGY CORP., HSINCHU (TW)

(21) Appl. No.: 12/917,586

(22) Filed: Nov. 2, 2010

(30) Foreign Application Priority Data
Nov. 4, 2009 (TW) 098137409

(51) Int. Cl. G05F 3/02

(52) U.S. Cl. 323/313

(57) ABSTRACT

A voltage source provides a first voltage which is independent of temperature variation and variable, and a voltage step-down circuit provides a second voltage to be subtracted from the first voltage to generate a reference signal. The second voltage has a first temperature coefficient, and the reference signal has a second temperature coefficient. By changing the first voltage, the second temperature coefficient changes accordingly.

### FIELD OF THE INVENTION

The present invention is related generally to a reference signal generator and, more particularly, to a reference signal generator and method for providing a reference signal with an adaptive temperature coefficient.

### BACKGROUND OF THE INVENTION

As shown in FIG. 1, a buck voltage regulator includes a pair of transistors M1 and M2 connected to each other by a phase node 12, and a controller chip 10 to provide control signals UG and LG for switching the transistors M1 and M2 respectively, to control an inductor current IL for charging a capacitor Co to generate an output voltage Vout. To protect the voltage regulator from damages, particular protection circuitry is provided in the voltage regulator. For example, for overcurrent protection, the current of the low-side transistor M2 is monitored to detect the overcurrent condition, typically by detecting the phase voltage VPH at the phase node 12. In order to identify an overcurrent condition, a reference signal generator is required for providing a reference signal to be compared with the phase voltage VPH, for example, if the phase voltage VPH is higher than the reference signal, it is referred as an overcurrent condition. From the circuit shown in FIG. 1, it can be derived the phase voltage

VPH=IL×RDS, [Eq-1]

where RDS is the on-resistance of the low-side transistor M2. Unfortunately, the on-resistance RDS is temperature dependent, and thus varies with temperature depending on its temperature coefficient. Therefore, the magnitude of the inductor current IL to trigger the overcurrent protection varies with temperature. Although it is feasible to provide the reference signal with a temperature coefficient for thermal compensation, the setting of such a temperature coefficient is difficult because the overcurrent protection circuitry inside the controller chip 10 has a different heat gradient from the low-side transistor M2 external of the controller chip 10. Conventionally, offset is used for compensation to eliminate the effect caused by the temperature coefficient of the low-side transistor M2, but the complicated calculation for offset design will increase workload and lead to unknown system design.

Therefore, it is desired a reference signal generator and method for providing a reference signal with an adaptive temperature coefficient.

### SUMMARY OF THE INVENTION

An object of the present invention is to provide a reference signal generator for providing a reference signal with an adaptive temperature coefficient.

Another object of the present invention is to provide a method for providing a reference signal with an adaptive temperature coefficient.

According to the present invention, a reference signal generator for providing a reference signal with an adaptive temperature coefficient includes a voltage source and a voltage step-down circuit connected to the voltage source. The voltage source provides a first voltage which is independent of temperature variation and variable, and the voltage step-down circuit provides a second voltage having a first temperature coefficient. The second voltage is subtracted from the first voltage to generate the reference signal having a second temperature coefficient. Therefore, the second temperature coefficient varies with the first voltage.

According to the present invention, a method for providing a reference signal with an adaptive temperature coefficient includes providing a first voltage which is independent of temperature variation and variable, providing a second voltage having a first temperature coefficient, and subtracting the second voltage from the first voltage to generate the reference signal having a second temperature coefficient. Therefore, the second temperature coefficient varies with the first voltage.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a typical buck voltage regulator;

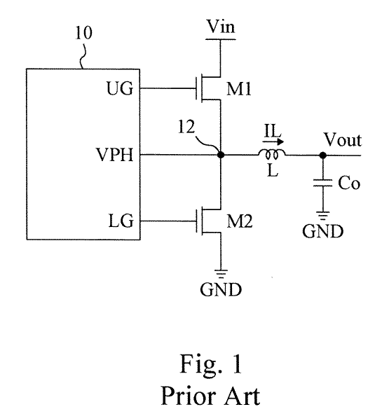

FIG. 2 is a circuit diagram of a first embodiment according to the present invention;

FIG. 3 is a circuit diagram of a second embodiment according to the present invention; and

FIG. 4 is a circuit diagram of a third embodiment according to the present invention.

### DETAILED DESCRIPTION OF THE INVENTION

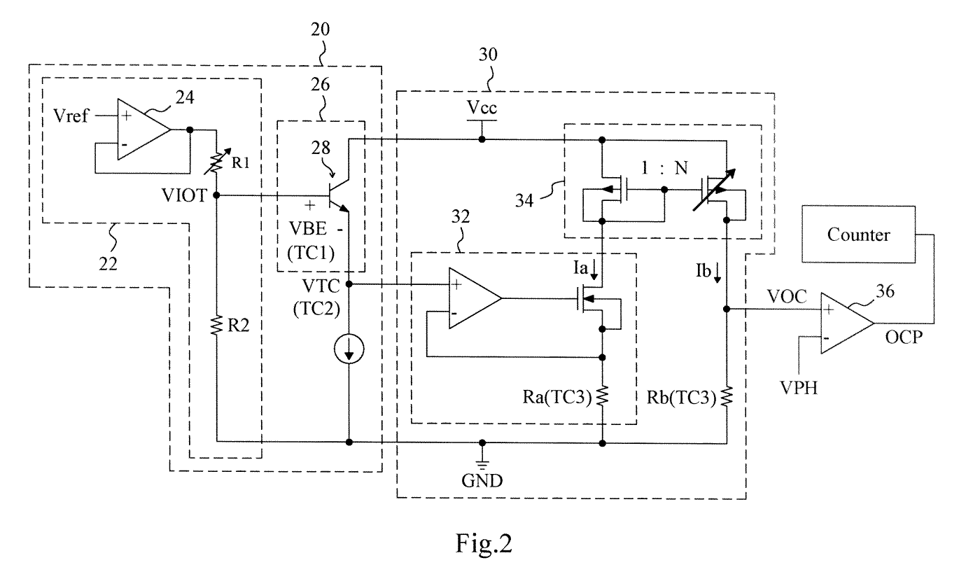

FIG. 2 is a circuit diagram of a first embodiment according to the present invention, in which a reference signal generator 20 includes a voltage source 22 and a voltage step-down circuit 26. In the voltage source 22, an operational amplifier 24 is configured as a voltage follower for applying a temperature independent reference voltage Vref to one end of a variable resistor R1, and a resistor R2 is serially connected to the variable resistor R1 to establish a voltage divider to divide the reference voltage Vref to generate a temperature independent voltage VIOT. When the resistance of the variable resistor R1 varies, the temperature independent voltage VIOT varies accordingly. The resistance of the variable resistor R1 can be changed via a fuse or by external fine tune. The voltage step-down circuit 26 includes a bipolar junction transistor (BJT) 28 whose collector is connected to a voltage source terminal Vcc, whose base is connected to the voltage source 22, and whose emitter is connected to a current source. By subtracting the voltage VBE between the base and the emitter of the BJT 28 from the voltage VIOT applied to the base of the BJT 28, a reference signal VTC is generated at the emitter of the BJT 28. The voltage VBE has a temperature coefficient TC1, and the reference signal VTC has a temperature coefficient TC2. Based on the values VTC(T1) and VTC(T2) of the reference signal VTC at two different temperatures T1 and T2 respectively, it can be obtained the temperature coefficient

$$\begin{matrix}TC 2 = [ VTC ( T 2 ) - VTC ( T 1 ) ] / VTC ( T 1 ) \\ = \{ VIOT - VBE ( T 2 ) - [ VIOT - VBE ( T 1 ) ] \} / VIOT - VBE ( T 1 ) \\ = [ VBE ( T 2 ) - VBE ( T 1 ) ] / VIOT - VBE ( T 1 ) ,\end{matrix} \qquad [ Eq \text{-} 2 ]$$

where VBE(T1) and VBE(T2) are the values of the voltage VBE at temperatures T1 and T2 respectively. In the equation Eq-2, both VBE(T1) and VBE(T2) are fixed values, so the temperature coefficient TC2 varies with the voltage VIOT. In other words, by changing the resistance of the variable resistor R1, the temperature coefficient TC2 of the voltage VTC can be adjusted. A voltage-to-voltage converter 30 amplifies the reference signal VTC to generate an overcurrent signal VOC, and a comparator 36 compares the overcurrent signal VOC with the phase voltage VPH to generate an overcurrent protection signal OCP. In the voltage-to-voltage converter 30, a voltage-to-current converter 32 converts the reference signal VTC into a current Ia, and a current mirror 34 mirrors the current Ia to generate a current Ib=N×Ia, which is applied to a resistor Rb to generate the overcurrent signal

$$\begin{matrix}VOC = Ib \times Rb = N \times Ia \times Rb \\ = N \times ( VTC / Ra ) \times Rb \\ = N \times VTC \times Rb / Ra .\end{matrix} \qquad [ Eq \text{-} 3 ]$$

By selecting the resistors Ra and Rb having a same temperature coefficient TC3, the overcurrent signal VOC and the reference signal VTC will have the same temperature coefficient TC2.

By adjusting the voltage VIOT, the reference signal generator 20 can generate a reference signal VTC having any temperature coefficient. Hence, the temperature coefficient of the overcurrent signal VOC used for overcurrent protection can be adjusted according to the temperature coefficient of the low-side transistor M2 so as to compensate for the effect caused by temperature variation, thereby allowing the magnitude of the inductor current to trigger the overcurrent protection to be temperature independent. In addition to being used in overcurrent protection, the reference signal generator 20 is equally applicable where it is necessary to generate a voltage or current having an arbitrary temperature coefficient or where thermal compensation is required for generating a signal independent of temperature variation.

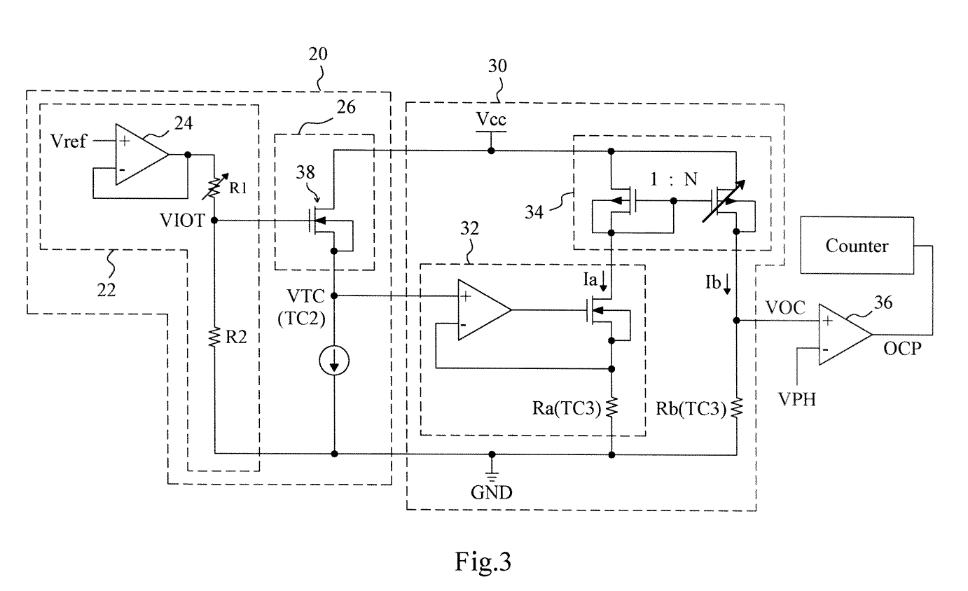

FIG. 3 is a circuit diagram of a second embodiment for the reference signal generator 20, in which a MOS 38 is used in place of the BJT 28 in the voltage step-down circuit 26 of FIG. 2. As shown in FIG. 3, the MOS 38 has a drain connected to the voltage source terminal Vcc, a gate connected to the voltage source 22, and a source coupled to the current source. The threshold voltage VT of the MOS 38 is subtracted from the voltage VIOT applied to the gate of the MOS 38 to produce a reference signal VTC at the source of the MOS 38. The threshold voltage VT of the MOS 38 has a temperature coefficient TC1, and the reference signal VTC has a temperature coefficient TC2. Based on the values VTC(T1) and VTC(T2) of the reference signal VTC at two different temperatures T1 and T2 respectively, it can be derived the temperature coefficient

$$\begin{matrix}TC 2 = [ VTC ( T 2 ) - VTC ( T 1 ) ] / VTC ( T 1 ) \\ = \{ VIOT - VT ( T 2 ) - [ VIOT - VT ( T 1 ) ] \} / VIOT - VT ( T 1 ) \\ = [ VBE ( T 2 ) - VT ( T 1 ) ] / VIOT - VT ( T 1 ) ,\end{matrix} \qquad [ Eq \text{-} 4 ]$$

where VT(T1) and VT(T2) are the values of the threshold voltage VT at temperatures T1 and T2 respectively. In the equation Eq-4, both VT(T1) and VT(T2) are fixed values, so the temperature coefficient TC2 varies with the voltage VIOT. In other words, the temperature coefficient TC2 of the voltage VTC can be adjusted by changing the resistance of the variable resistor R1.

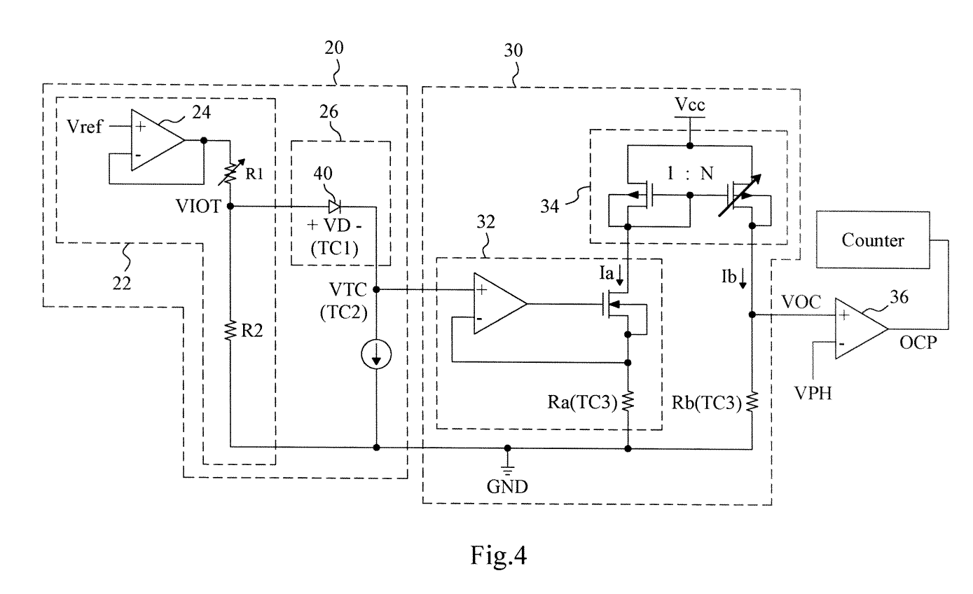

FIG. 4 is a circuit diagram of a third embodiment for the reference signal generator 20, in which a diode 40 replaces the BJT 28 in the voltage step-down circuit 26 of FIG. 2. As shown in FIG. 4, the anode and the cathode of the diode 40 are connected to the voltage source 22 and the current source respectively, so that a forward voltage VD exists between the two ends of the diode 40. After the forward voltage VD of the diode 40 is subtracted from the voltage VIOT applied to the anode of the diode 40, a reference signal VTC is generated at the cathode of the diode 40. The forward voltage VD has a temperature coefficient TC1, and the reference signal VTC has a temperature coefficient TC2 which, as explained previously, varies with the voltage VIOT. Therefore, by changing the resistance of the variable resistor R1, the temperature coefficient TC2 of the voltage VTC can be adjusted.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A reference signal generator for providing a reference signal with an adaptive temperature coefficient, the reference signal generator comprising:
a voltage source for providing a first voltage which is independent of temperature variation and variable; and
a voltage step-down circuit connected to the voltage source, operative to provide a second voltage having a first temperature coefficient to be subtracted from the first voltage to generate the reference signal having a second temperature coefficient varying with the first voltage.

2. The reference signal generator of claim 1, wherein the voltage source comprises:
a variable first resistor; and
a second resistor connected to the first resistor to establish a voltage divider to divide a third voltage to generate the first voltage;
wherein the third voltage is independent of temperature variation.

3. The reference signal generator of claim 1, wherein the voltage step-down circuit comprises a BJT having a base connected to the voltage source and an emitter for providing the reference signal, with the second voltage existing between the base and the emitter of the BUT.

4. The reference signal generator of claim 1, wherein the voltage step-down circuit comprises a MOS having a gate connected to the voltage source and a source for providing the reference signal, with a threshold voltage as the second voltage.

5. The reference signal generator of claim 1, wherein the voltage step-down circuit comprises a diode having an anode connected to the voltage source and a cathode for providing the reference signal, with the second voltage existing between the anode and the cathode of the diode.

6. A method for providing a reference signal with an adaptive temperature coefficient, the method comprising the steps of:
providing a first voltage which is independent of temperature variation and variable;
providing a second voltage having a first temperature coefficient; and
subtracting the second voltage from the first voltage to generate the reference signal having a second temperature coefficient varying with the first voltage.
